(19) United States
(12) Patent Application Publication
(10) Pub. No.: US 2025/0136793 A1
(43) Pub. Date: May 1, 2025

(54) SYSTEM AND METHOD FOR PROCESSING A STARTING MATERIAL TO GIVE A SHAPEABLE SOLUTION, ACCORDING TO THE DRY DISSOLUTION METHOD

(71) Applicant: LIST TECHNOLOGY AG, Arisdorf (CH)

(72) Inventors: Bernhard Stützle, Riedisheim (FR); Judith Andrea Michelle Günther, Lörrach (DE); Manuel Steiner, Basel (CH); Roland Kunkel, Frankfurt (DE); Daniel Witte, Grenzach-Wyhlen (DE)

(73) Assignee: LIST TECHNOLOGY AG, Arisdorf (CH)

(21) Appl. No.: 18/834,758

(22) PCT Filed: Jan. 31, 2023
(86) PCT No.: PCT/EP2023/052365

§ 371 Date: Jul. 31, 2024

(30) Foreign Application Priority Data
Jan. 31, 2022 (DE) 10 2022 102 177.7
Jan. 31, 2022 (EP) 22154311.9

(51) Int. Cl. C08L 1/02; C08B 1/00

(52) U.S. Cl. CPC C08L 1/02; C08B 1/003

(57) ABSTRACT

The invention relates to a method for processing a shapeable solution from a starting material that consists of cellulose, water and a functional medium, according to the dry dissolution method, wherein the starting material is first supplied to a high-shear unit, wherein a transfer mixture is obtained from the starting material in the high-shear unit, and the transfer mixture is then supplied to a kneader-mixer for dissolution.

### BACKGROUND OF THE INVENTION

The invention relates to a method and a system for processing a starting material to give a moulding solution, according to a dry dissolution method.

EP 0 906 455 A1 describes, for example, that a moulding solution is produced from fibrillar cellulose powder and liquid NMMO in a dry dissolution method in a twin-screw extruder, which has to be stabilised in a following storage container with a pressure regulator.

EP 1 191 038 A1 describes a dry dissolution method, wherein in a twin-screw extruder a swollen mixture is produced from subcooled liquid NMMO hydrate and cellulose powder, which mixture is supplied to a single-screw extruder, in order to subsequently be dissolved in the single-screw extruder. In detail, it is a question of producing a starting material which is processed, by melting, to form a solution.

EP 1 144 455 B1 describes a method for mixing and homogenising cellulose and aqueous NMMO in two shear zones of a first apparatus, to form a homogeneous suspension. In this case, the amount and the water content of the NMMO is matched to the possible water content of the cellulose, such that the NMMO content in the liquid phase of the suspension that is formed is between 70 to 80 mass. %. Furthermore, a schematic system is shown, consisting of a first apparatus for producing the suspension, and a second apparatus, connected to the first apparatus, as an evaporation stage. In view of the invention described below, EP 1 144 455 B1 thus relates to the production of a suspension having a water content that is so high that the following process stage for producing a spinning solution is characterised by evaporation of water.

WO 2005/000 945 A1 describes a method which contains mixing of N-Methylmorpholine N-oxide (NMMO) powder with ground cellulose, and subsequent dissolution, wherein both processes take place in a single twin-screw extruder.

WO 2006/071 101 A1 describes dissolution of a paste in an extruder to form a moulding solution, wherein the paste is produced in a preceding kneader from an NMMO solution and ground cellulose, wherein the NMMO solution consists of NMMO and a small portion of cellulose powder. WO 2006/071 101 A1 thus describes connecting a kneader upstream of an extruder, in order that said extruder can produce a moulding solution.

All these dry dissolution methods use an extruder for dissolution of the cellulose. They differ by different preceding process stages. The reason is the high shearing intensity of extruders. However, dry dissolution methods are currently not used for large capacities on an industrial scale. The reason is the limited capacity of extruders. Although extruders, with their smaller diameters D compared with kneader-mixers, small clearances, and high speeds of the shaft, are well suited for mixing two powders (a frozen functional medium such as NMMO at room temperature, and ground cellulose, wherein the frozen functional medium in powder form melts in the extruder, by introduction of shear energy, to form a liquid functional medium), or a cellulose powder with a functional medium in the liquid state of aggregation, they at the same time, as a result, have only a short dwell time of the product compared with kneader-mixers, because the small clearances lead to significantly smaller process volumes than in the case of kneader-mixers, and the high speeds of the shafts at the same time—in contrast to kneader-mixers-forcibly convey the product and thus limit the dwell time. This limited dwell time is furthermore additionally intensified by the very high mechanical dissipation per process volume.

An insufficient dwell time (in the sense of shorter than the dissolution time required for the stirring element-specific mechanical action) means insufficient homogeneities and dissolution state of the moulding solution, such that the following shaping, for example during spinning, leads to fibre tears, clogging of spinning nozzles, or to shorter filter service lives.

Alternatively, with increasing dwell time (in order to reach the necessary dissolution time) or speed of the shaft (in order to achieve the necessary mechanical action) in the extruder, the mechanical energy input, and thus the risk of substantial overheating of the product or the product components increases, which constitutes a risk of product damage and a risk of decomposition, which can be associated with significant costs due to price reductions resulting from product damage, and the replacement of—in the case of NMMO and in particular IL very expensive-functional medium. Furthermore, in the discharge-side region of the extruder, dissipation of heat from the product, by means of cooling, may be necessary, in order to prevent overheating or substantial overheating, which entails an energy loss, increases the energy costs, and becomes increasingly more difficult as the diameters increase, due to a reducing surface/process volume ratio of extruders, and ultimately also limits the structural size of suitable extruders.

In the case of NMMO as the functional medium, the risk of explosion is common to all the above-mentioned methods for producing a moulding solution, also using an extruder. On account of the small, non-cohesive free volume in the process chamber of extruders, there is furthermore no easy way of monitoring and relieving pressure build-up, on account of decomposition processes of the functional medium, over the entire process chamber.

In addition to the extruders described above, kneader-mixers are also known to a person skilled in the art. They preferably comprise exactly one or exactly two kneader shafts, which serve for carrying out highly viscous and crust-forming processes, which can be operated under vacuum, atmospheric pressure, or at excess pressure, and can be heated or cooled via thermal exchange surfaces. Furthermore, the kneader shaft and the shaft structures thereof, in the case of typically present product viscosities, can very effectively heat the product by rotation and the resulting energy dissipation.

If precisely one kneader shaft is present, then this is a single-shaft kneader-mixer, which is described for example in CH 674 472 A5. In this case, during operation shaft structures of the kneader shaft preferably mesh with static structures of the housing, for example known as mating hooks. If precisely two kneader shafts are present, then this is a twin-shaft kneader-mixer, which is described for example in DE 41 18 884 A1. The shaft structures of the kneader shafts preferably mesh with one another during operation.

The at least one kneader shaft comprises shaft structures in the form of discs, and bars fastened thereon, wherein the shaft structures of the at least one kneader shaft are configured to mesh, during operation, with the shaft structures of a second kneader shaft or with stationary mating elements present in the kneader-mixer. Kneader-mixers having elements that mesh in this way are known and are referred to as “self-cleaning” because the described meshing detaches any build-up of deposits from the meshing elements.

Kneader-mixers comprise an opening to the process chamber for the input of the product into the process chamber of the kneader-mixer (also referred to as input opening), and a further opening to the process chamber of the kneader-mixer for the discharge of the product out of the process chamber of the kneader-mixer (also referred to as discharge opening). The input and discharge opening are typically arranged at the regions of the kneader-mixer that are opposite one another, viewed axially. The input opening can also consist of more than one opening, which are distributed over an axially extending part of the length of the kneader-mixer. Further openings to the process chamber of the kneader-mixer can typically be arranged in the top half of the process chamber (also referred to as gas discharge opening), in order to be able to discharge gases, released in the kneader-mixer, via separate openings, to the process chamber, and which are typically arranged-viewed axially-between the input and discharge opening. If the kneader-mixer comprises a dome, then the chamber (also referred to as dome gas chamber) delimited by the insides of the dome directly adjoins the gas chamber of the process chamber, and these two form a common gas chamber. A dome is an attachment that extends vertically upwards, is in the style of a chimney, and is arranged directly on the gas discharge openings of the kneader-mixer, and in the upper region of which typically an opening for the discharge of gases (also referred to as exhaust) is located (also referred to as exhaust opening). Some of the inner surfaces of the dome can also be thermally heated or cooled. Kneader-mixers can also be equipped with more than one dome, which are then also referred to together as domes.

The above-mentioned bars, mating hooks and shaft structures are also combined under the designation kneading elements. There is a plurality of methods for producing a moulding solution from pulp (or also cellulose, wherein the difference between pulp and cellulose is irrelevant for the interpretation of this patent application, and the two terms can be used interchangeably). These can differ inter alia according to the water content in the starting material that is excess for a moulding solution. A person skilled in the art additionally knows the method for producing a moulding solution from pulp according to the dry dissolution method, in which an ionic liquid, instead of NMMO, is used as the functional liquid. IL (ionic liquids) relates to a group of organic compounds which, despite their ionic structure, have a low melting point (<100° C.) and are therefore also referred to as molten salts. The use of IL as a functional medium thus always means an embodiment, within the group of the ionic liquids, that is suitable for the dry dissolution method.

A person skilled in the art knows that IL typically tends towards thermal decomposition at increased temperatures, and therefore in processes comprising a heated IL the temperature of the IL must be kept below its decomposition temperature.

A person skilled in the art also knows that a decomposition of the NMMO begins with the reduction of the water content of an NMMO/water/cellulose mixture at increased temperatures. In the case of temperatures of typically above 140° C., as the water content reduces there is an increasing risk of explosion, for example due to explosive autocatalytic decomposition, from which a further temperature increase, and thus acute risk of explosion, follows. Depending on the composition of the mixture, decomposition can also already be observed from temperatures above 125° C., since the decomposition temperature can reduce due, for example, to the presence of reducing agents (such as cellulose) and heavy metal ions (such as iron ions).

A person skilled in the art furthermore knows, within the context of the invention, the situation the substantial overheating to be a problem, in which, in order to avoid decomposition of the functional medium, great attention must be paid to the guidance of the temperature of the product (in the following also referred to as product temperature). Said person therefore selects a process in which the sought product temperature and the equilibrium temperature are below the decomposition temperature.

In the case of a multicomponent mixture, as is present in the case of the cellulose/functional medium/water mixture, each composition of the mixture is assigned an equilibrium temperature, at prevailing process conditions (pressure), at which temperature the mixture begins to boil. If energy is supplied into the multicomponent mixture, then a some of the volatile components (here water) evaporate. At the same time, the composition of the mixture changes, as a result of which the equilibrium temperature also changes as a consequence. For example, the mixture heats up in the case of supply of energy, while its composition changes along its equilibrium curve due to evaporation of volatile components.

In the case of NMMO as a functional medium, in the case of existing transport limitation, exothermic decomposition processes furthermore lead to local material overheating (hotspots), from which the reaction heat cannot be dissipated to a sufficient extent. This subsequently triggers further exothermic decomposition processes.

Substantial overheating can, however, also relate to a decomposition of the cellulose or of the cellulose/functional medium/water mixture (or, according to definition, of the product), in that it leads, at temperatures that are too high, possibly in conjunction with increased shear action, which is typically present at increased viscosities, to a reduction in the degree of polymerisation (known to a person skilled in the art as DP) of the cellulose.

A person skilled in the art knows that dissolution process do not take place instantaneously, but rather within a time period, at a dissolution speed, and require a minimum dissolution time. A person skilled in the art furthermore knows that dissolution speeds are influenced by various factors, such as the temperature, and that, in addition to the temperature, the concentration of the functional medium and the mechanical treatment of the mixture also exert an influence on the dissolution speed. For example, in the case of the same composition and same temperature, different dissolution states can occur by different mechanical treatment of the material at the same treatment duration.

A person skilled in the art furthermore knows methods for producing a moulding solution consisting of pulp, according to the direct dissolution method, the starting material of which has a water content that is so high, compared with the water content in the moulding solution, that a substantial part of the process and of the device is influenced by the evaporation of water content (wet dissolution method), as described for example in WO 1994/006530 A1, wherein NMMO is used as the functional medium, and a thin-film evaporator is used for evaporating water. The disadvantage of the wet dissolution method is the high energy expenditure, which is caused by the evaporation of water.

Therefore, in addition to the suitable water content for producing a moulding solution, mechanical action on the product is also required, which action is achieved by the purposely selected geometry of a mixing element, and which must take place for a certain amount of time.

For example, methods are also known for producing a moulding solution which use more mechanical action on the product, which action is achieved by the purposely selected geometry of a mixing element, and which must, however, take place for a certain amount of time.

In a non-limiting manner, heatable or coolable insides of apparatuses or machines in process technology, such as kneader-mixer, extruder or thin film evaporator housings, as well as of kneader shaft(s) and discs of kneader-mixers can be configured as thermal exchange surfaces.

Discs of kneader shafts of kneader-mixers, which are configured as thermal exchange surfaces, comprise drilled holes for electrical heating elements, or cavities for a heat carrier medium or cooling medium, wherein the latter comprises an inflow, which is fed by the inflow in the kneader shaft, and an outflow, which flows back to the return flow in the kneader shaft. The cavities can typically be configured as double walls or drilled holes, and for this purpose require greater wall thicknesses and larger dimensions of the shaft structures and thicker-walled kneader shafts, and in this case cause a significantly greater manufacturing outlay compared with discs free of a cavity (in the following also referred to as free of a heating cavity), which typically can be constructed smaller and more easily due to thermal exchange surfaces being omitted.

Kneaders are known to a person skilled in the art and are described for example in JP 1994 055267 B2. They differ from extruders by a larger, free process volume and reduced shear action, and from kneader-mixers in particular by the one-dimensional meshing and by the associated absence of bars, which lead to the mixing effect typical for kneader-mixers. Kneaders can be operated continuously and discontinuously.

Z-kneaders and sigma blade mixers are known to a person skilled in the art and are described for example in DE 1 058 188 A1. They are characterised by two Z-shaped or multi-Z-shaped kneading arms, which are each arranged in a large-volume, often troughlike, reactor chamber, so as to be rotatable about a horizontal axis arranged in parallel with the axis of the other kneader arm and so as to engage in one another or so as not to engage in one another, and can be operated only in a batchwise manner. Due to their large volume and the batchwise operation, they are suitable in particular for mixing in a larger solid content and for premixing, as also described in DE 37 20 325 A1, in particular also because the metering is much easier due to the batchwise operation. However, owing to the large free spaces and the lack of a continuous mode of operation, they are not suitable for sufficiently homogenising and dissolving pulp on an industrial scale.

### SUMMARY OF THE INVENTION

The problem addressed by the present invention is that of overcoming the disadvantages from the prior art.

In particular, a system and a method for processing a starting material to give a moulding solution, according to the dry dissolution method, for processing a transfer mixture to give a moulding solution, should be described, which primarily makes it possible to overcome the disadvantages of the dry dissolution method of the prior art, in particular to increase the product quality and in the process to be able to increase the capacities.

The features disclosed herein lead to the solution to the problem.

Advantageous embodiments are also described herein and in the dependent claims.

The present invention relates to a method and a system which inter alia comprises a kneader-mixer for processing a transfer mixture, as the last process stage of an at least two-stage process, according to the dry dissolution method, in a kneader-mixer, wherein all the facts mentioned in the scope of the statement of the problem are taken into account. In this case, a high-shear unit is connected upstream of the kneader-mixer.

In this case, the kneader-mixer is configured such that it is generally of a large volume compared with extruders, and in this case allows for longer dwell times relative to dwell times, and has a lesser shear action relative to a high-shear unit.

The high-shear unit is characterised, compared with the kneader-mixer, by a significant shear action, and with shorter dwell times compared with the kneader-mixer.

The mixing, kneading and shearing action in a process member such as in particular a high-shear unit or a kneader-mixer, on a product, results substantially from the interaction of the product with the elements that rotate relative to one another in the process member, due to the rotation of the shaft (also referred to as kneader-mixer interaction), and depends on the process and product volume (filling level), the design of the geometry and surfaces of the elements in the process chamber, the rotational speed of the at least one shaft, as well as the viscosity and the dwell time of the product, to be processed, in the process member.

In the context of the invention, any starting, passage and final state from the starting material to the solution is referred to as the product.

The shear action results from the shearing multiplied by the processing time during which the shearing takes place.

A shearing that is as large as possible is achieved by a shear surface that is as large as possible and that can extend both in the direction in which the two shear surfaces move relative to one another, and orthogonally thereto. Furthermore, as narrow as possible a shear gap also increases the shearing, specifically the distance between the two shear surfaces measured orthogonally to the shear surface. Furthermore, as high as possible a relative speed of the two shear surfaces also increases the shearing, as well as the highest possible filling level of product in the shear gap.

A high-shear unit is a process member having at least one shaft, the rotational speed of which is-typically significantly-higher than that of kneader shafts of kneader-mixers, and/or of which the clearances of the mixing or kneading elements with respect to wall surfaces and the mixing or kneading elements of a second shaft are significantly smaller, and/or the shear surface-to-process volume ratio is significantly larger than in the case of kneader-mixers, and/or their exposure time-typically by a batchwise rather than continuous mode of operation—is significantly longer than in the case of kneader-mixers, such that the heavy action resulting from the combination of these properties is significantly greater than that of kneader-mixers of a comparable process volume. In terms of apparatus, the significant shear action can be achieved using a high-speed high-shear unit which is characterised by a process chamber that has a small volume compared with kneader-mixers, comprising at least one shaft that rotates quickly compared with kneader-mixers, having small gap sizes compared with kneader-mixers, and short dwell times compared with kneader-mixers, and, like kneader-mixers, continuous operation. A typical example of a high-speed high-shear unit is an extruder or a high-speed mixer. In this case, high-speed mixers differ from extruders in that they achieve the significant shear action by comparatively high speeds at low torques, such as a Ystral® mixer or solid-liquid mixer by IKA®, or what is known as a KRIMA® disperser by Cellwood Machinery®. High-speed mixers are characterised, compared with extruders, in particular by higher speeds, shorter dwell times, and lower torques of the shaft. In terms of apparatus, a significant shear action can also be achieved by a large-volume high-shear unit which is characterised by larger shear surfaces compared with kneader-mixers, which have preferably adjustable gap sizes compared with kneader-mixers, in a large process chamber, having at least one shaft that rotates quickly, similarly to a kneader shaft, and achieved by dwell times that are freely selectable in length and, unlike industrially operated kneader-mixers, by exclusively batchwise operation. A typical example of a large-volume high-shear unit is a Z-kneader or a sigma blade mixer. Typical dwell times of high-speed mixers are at most 10 seconds, those of extruders are at most 5 minutes, and those of large-volume high-shear units are at least 15 minutes.

Placement of the kneader-mixer after the high-shear unit in the dry dissolution method and in the system makes it possible to make specific use of the technical advantages of the kneader-mixer for the dry dissolution method. In this case, it has been found to be advantageous for the high-shear unit to be connected upstream of the kneader-mixer. This is because, as a result, according to the invention, the high-shear unit supplements the mode of operation of the kneader-mixer in that it makes use of the mix—in ability of the high-shear unit and compensates for the disadvantage of a high-shear unit, specifically the limited dwell time of the high-speed high-shear unit or the lack of a continuous operating mode of the large-volume high-shear unit.

In the context of the invention, the mixture of water, cellulose and a functional medium, introduced into the dry dissolution method, is considered a starting material. In this case, the transfer mixture corresponds to an intermediate step, in which the starting material has been mixed in the high-shear unit and has not yet been processed into a moulding solution. In the context of the invention, a moulding solution refers to what is subsequently substantially suitable for deforming, such as in particular for spinning—also referred to as extruding.

The product volume corresponds to the volume of product, to be processed, contained by a process member, such as the kneader-mixer according to the invention. The radio of product volume and process volume corresponds to the filling level.

The process volume corresponds to the volume in which a process member, such as the kneader-mixer according to the invention, can contain the product to be processed. In the case of rotor-stator systems, this means in particular the stirred volume, and therefore the non-stirred volumes, for example in connection nozzles, are not to be interpreted as process volumes. This can be determined for example by “volumetric measurement in litres”, in that the process chamber is completely filled with a liquid, the volume of which is measured.

The two-dimensional (radial and axial) meshing, typical of kneader-mixers, constitutes an entirely different mixing/kneading principle compared with the case of extruders, in which the mixing effect typically takes place only radially and having zones arranged at an axial distance from one another, by means of mixing/kneading blocks, or by forced partial return flow, and always on a comparatively small scale.

Since kneader-mixers are typically operated at a partial filling level, the input current and typically also the through put of the discharge member can be selected substantially separately (in the sense of independently of the speed of the kneader shaft), and since, in contrast with extruders, the product in kneader-mixers can easily evade axial conveying in the case of a mixing/kneading interaction, in the case of kneader-mixers the speed of the kneader shaft is just one of the variables influencing the throughput, which is matched to the actually present or sought filling level or its axial distribution, the input current, the output current, and the throughput, and, compared with extruders, not an influencing variable that builds up substantial axial pressure. The mixing/kneading action of kneader-mixers for a give machine and a given product also depends not only on the speed, but rather in particular also on freely selectable adjustment variables of dwell time and filling level.

In the case of extruders, in contrast, not only the mixing/kneading effect but rather also the product conveying depends substantially directly on the speed (forced conveying), which results in the product conveying being quick on account of the high speeds necessary for significant mixing, and consequently the dwell time is short compared with kneader-mixers. This results in particular from the property, typical for extruders, that for a given extruder the dwell time cannot be set independently of the speed. The mixing/kneading action of extruders is therefore achieved only by the reciprocal engagement of the rotating shafts and mixing/kneading zones arranged axially spaced, in interaction with the product. For a given machine having a given shaft configuration, and a given product (by extension having a given product viscosity, which in turn is also again dependent on the temperature and speed or shearing), this depends substantially only on the speed. Additionally, in order to achieve a certain dwell time, extruders must have a greater shaft length L compared with kneader-mixers: The length/diameter ratio L/D of extruders is significantly greater than in the case of kneader-mixers, and is typically 24 to 48 compared with 3 to 6 in the case of typical kneader-mixers.

The traditional aim of both kneader-mixers and extruders is to process masses with a viscosity that is so significantly increased that they can no longer be stirred or mixed using a conventional vertical stirring element, typically mounted on one side, in a large-volume tank, and that the mechanical energy input is process-determining.

The term “dry dissolution methods” brings together all methods which serve for producing a moulding solution from a starting material, and in this case do not include any, or no significant, removal of water (in particular evaporation of water). In this case, the starting material typically has a 0% to 10% higher water content than is necessary for the dissolution of the cellulose. Significant removal of water means that this determines the configuration, in the sense that a system must be configured larger on account of the water removal or must be supplemented by an additional apparatus that processes the product or an additional machine that processes the product (quite apart from a system for condensing exhaust vapour streams resulting from evaporation). Dry dissolution methods include both dry direct dissolution methods having NMMO or a IL as the moulding solution, and protolyte dissolution methods having a moulding solution based on a protolyte (acid or lye), such as sodium hydroxide solution or phosphoric acid.

A last process stage is defined in that in said last process stage a moulding solution is produced from the transfer mixture. Independently thereof, and not to be referred to as a process stage in the context of the invention, are, for example subsequently, a discharge member and further interposed pumps, filters and buffer tanks or the like, which are still required until the spinning/shaping and typically serve for transport or filtration, degassing, or pressure and mass flow stability of the moulding solution.

In this case, the processing of the transfer mixture to form a moulding solution consists of a dissolution process, also referred to as dissolution. This requires a particular time duration for a particular mixing and kneading intensity (determined in particular by the specific embodiment of the kneader-mixer and the rotational speed of the kneader shaft) for a particular product (determined in particular by the type and proportion of cellulose and functional medium). This part of the process ultimately results in a moulding solution stream, which can subsequently be supplied to deformation. Since the design for a certain mixing and kneading intensity and a certain product is time-determined, the process volume of the kneader-mixer is substantially directly proportional to the capacity of the moulding solution stream (also referred to as moulding solution stream capacity). This so-called volume scale-up is the opposite of the surface scale-up, known to a person skilled in the art, of a kneader-mixer for producing a moulding solution, the process of which is characterised by the evaporation of water, for which purpose the kneader-mixer must have sufficient heating surfaces, which is size-determining. Conversely, in the case of a surface scale-up, the kneader-mixer could be smaller, if it had to evaporate less or no water.

This furthermore has the advantage that the increase in the mixing and kneading intensity in the extruder on account of the forced conveying of the product is always associated with a reduction i the dwell time of the product, while in the kneader-mixer the mixing and kneading intensity can be increased, and the dwell time can be freely selected (i.e. also increased or reduced) independently thereof. The kneader-mixer according to the invention is used for carrying out the mixing and kneading of the product after its exit, as a transfer mixture, from a high-shear unit, as a preceding process member, which mixing and kneading is necessary for achieving a moulding solution. This makes it possible to use the high-shear unit to its strengths, specifically for mixing two powders or powder in a liquid, and thereafter further treating the product in the kneader-mixer according to the invention, with mixing and kneading action, the shear action of which on the product is much less than is typica in high-shear units, and thus in particular more time is available for dissolving.

Due to the significant shear action, the high-shear unit creates an advantageous starting state of the product, which is characterised at least in that this has the necessary homogeneity, as a transfer mixture for processing in the kneader-mixer.

In the case of use of a high-speed high-shear unit as the high-shear unit, it is possible to generate tenfold to hundredfold power inputs per process volume (specific mechanical power input) compared with kneader-mixers, under typical process conditions. In the high-speed high-shear unit, the much higher specific mechanical power input produces close contact of the components of the starting material, and thereby creates an advantageous starting state for the following dissolution process. This advantageous starting state of the product is characterised in that, as a transfer mixture for processing in the kneader-mixer, this can also contain certain portions of dissolved cellulose, in addition to having the necessary homogeneity. The continuous mode of operation means that this is further processed directly in the kneader-mixer to form a moulding solution, before decomposition of the product can occur.

In the case of use of a large-volume high-shear unit as the high-shear unit, it is possible to functionally combine the high shear action, in particular due to large shear surfaces of long shear gaps, in combination with long dwell times, as can be easily achieved with the batchwise mode of operation.

In the case of use of a large-volume high-shear unit for producing the transfer mixture, the batchwise mode of operation preferably prevents the transfer mixture from already containing fractions of dissolved cellulose or dissolved pulp, since such direct further processing in the kneader-mixer is not ensured, due to the batchwise mode of operation, and this can lead to partial decomposition and non-uniform product quality. This also means that the transfer mixture that is produced by a large-volume high-shear unit preferably has a certain storage stability.

Storage stability means that the product can be stored without changing its composition and its chemical and physical properties to such an extent that it is on longer suitable for further processing without an unacceptable reduction in product quality.

In this case, it is irrelevant whether the at least one high-shear unit is connected to the kneader-mixer according to the invention directly or via an intermediate transfer member such as a gear pump, and whether it is operated in a batchwise manner or continuously. Furthermore, it is also conceivable for the high-shear unit not to be connected to the kneader-mixer according to the invention, and for the transfer mixture to be temporarily stored in a tank and to be fed to the kneader-mixer according to the invention in a temporally and locally offset manner.

Even if the kneader-mixer according to the invention functions independently of whether the high-shear unit is operated in a batchwise manner or continuously, the mode of operation of the kneader-mixer according to the invention is different. In the case of a continuously operated high-shear unit, the task of the kneader-mixer according to the invention is that of extending the mixing and kneading time of the product, until the dissolution time is reached, since the dwell time available in a continuously operated high-shear unit is typically less than the required dissolution time. In the kneader-mixer according to the invention, the product is mixed and kneaded in such a gentle manner compared with the high-shear unit, owing to the mentioned reduced shear action, that the product does not or does not significantly overheat.

In the case of a high-shear unit operated in a batchwise manner, such as typically a Z-kneader, from which the transfer mixture is discharged at the end of each batch (i.e. in a batchwise manner), preferably by a continuous discharge member, and supplied to the kneader-mixer according to the invention, the kneader-mixer according to the invention in particular also ensures, besides additional kneading and mixing to form a homogeneous moulding solution, a continuous moulding solution stream, with which the shaping and spinning process, which likewise takes place continuously and is very sensitive to fluctuations, is fed. In this case, the fluctuation sensitivity in particular relates, in addition to the continuity of the mass flow, to the continuity of the quality of the moulding solution, in particular the homogeneity, viscosity and composition, as well as the influencing of these properties by decomposition processes of the cellulose and of the functional medium. A batchwise moulding solution production is not suitable on an industrial scale owing to the fluctuation sensitivity of the shaping and spinning process. Furthermore, a process chamber that discharges only in a batchwise manner also does not have any self-cleaning by afterflow of product, as in continuous operation, which leads to time-consuming cleaning outlay and loss of product, especially since moulding solutions are typically much more tacky than the product before the dissolution state.

A transfer member also includes conveying members, tanks, or combinations of these elements. Conveying members are known to a person skilled in the art, and in particular include non-compressing embodiments. The tank can be stirred or circulated, in particular in order to counteract demixing.

It is furthermore possible, during processing of the transfer mixture to form a moulding solution, to reduce a water content remaining in the transfer mixture to the content required for the dissolution process and the moulding solution. However, in addition to the dissolution task of the kneader-mixer according to the invention, this evaporation task is firstly optional and secondly subordinate thereto and is not decisive for the installation size. For this evaporation, in addition to the mechanical energy input resulting from the viscosity in combination with a process volume and with at least one rotating kneader shaft, the kneader-mixer may furthermore require heating surfaces for a thermal energy input, which surfaces are arranged in the kneader-mixer.

Thus, in the context of this invention, the capacity of the kneader-mixer means on the one hand an evaporation capacity and on the other hand a moulding solution flow capacity.

In the direct dissolution method, the kneader-mixer according to the invention makes use of the hitherto unknown finding that below a certain water content in the transfer mixture kneader-mixers can no longer be configured having a smaller process volume, without the moulding solution flow capacity having to be reduced in the process. This is due to the fact that, from this water content onwards, the process volume required for the dissolution time must necessarily be applied—the moulding solution flow capacity is thus configuration-determining. Conversely, this means that, in the direct dissolution method, the kneader-mixer has to be built larger, with increasing water content in the transfer mixture, from a certain water content, than would be necessary for the moulding solution flow capacity, because the evaporation capacity requires a larger structure, in order to arrange corresponding heating surfaces in the kneader-mixer.

The kneader-mixer according to the invention therefore consists of a kneader-mixer of which the size exclusively meets the requirements of a moulding solution flow capacity.

The optional evaporation capacity of the preceding process member for producing the transfer mixture by evaporation of substantially water (referred to in the following as main evaporation) is adapted correspondingly, and results from the heating surfaces and the viscosity-dependent and kneader shaft speed-dependent mechanical energy input ability of the kneader-mixer. It is also provided, within the context of the invention, that the transfer mixture is produced from a starting material in a plurality of preceding process members. In this case, in the context of this invention, said preceding process members can be connected in series or in parallel, and relate to the high-shear unit.

The kneader-mixer according to the invention for processing the transfer mixture to form a moulding solution according to the dry dissolution method is a kneader-mixer having a feed, a housing, at least one kneader shaft that rotates in the housing, and a discharge, wherein the feed introduces a product, in the form of a transfer mixture consisting substantially of cellulose, water and the functional medium, into the housing, wherein the transfer mixture is processed by stirring, such that the moulding solution results, wherein the moulding solution flows into the discharge with a supply current, and then is fed to the following process member, for example the discharge screw, the transfer pump, a filter station, the buffer tank, the spinning pump, and the spinning nozzle.

In this case, as an embodiment the mechanical and thermal energy input can also be used for evaporating a portion of the water until a moulding solution is present. This is the case when the water content in the starting material is higher than is necessary for a moulding solution.

A further embodiment is characterised in that an excess water content in the starting material is purposely selected such that the mechanical energy introduced in the kneader-mixer by the mixing and kneading effect during a particular dwell time is used firstly for the intended product heating, and secondly for the evaporation of the water content, such that preferably overheating, but at least significant overheating, of the product is prevented. This also has the above-mentioned advantage, compared with the variants that make do entirely without evaporation, of pre-swelling, and relieves a recovery of the functional medium from the spinning bath or shaping bath. In this case, a preferred embodiment consists in water content in the starting material or in the transfer mixture that is excessive compared with a moulding solution being purposely selected in such a way that the energy required for its evaporation originates from the mechanical energy input taking place by dissipation, and no thermal energy input via heated surfaces, and preferably also no thermal energy discharge for preventing overheating or substantial overheating, via cooled surfaces, is required. The advantage of this embodiment is on the one hand the higher water content in the functional medium, which reduces its machine production costs and functional agent recovery costs, and on the other hand the quicker production of the transfer mixture, because the water promotes the soaking of cellulose and functional medium. Avoiding heated or cooled surfaces relates in particular to the discs attached to the kneader shafts, but preferably additionally also to the shafts and/or the inner housing surfaces. In terms of apparatus, the former means that the discs can be configured merely free of a heating cavity or also purely as supports having a minimised side surface, which relieves the kneader shaft and simplifies the production thereof. Furthermore, this means there is uniform loading of the kneader shaft, which inter alia generally leads to a longer service life of the kneader-mixer.

Practice with kneader-mixer types used hitherto by the inventors for the moulding solution methods according to the invention, according to the direct dissolution method, having NMMO as the functional medium, has shown that the dwell time in the kneader-mixer is in a range between 2 and 15 minutes, wherein the dwell time is contingent largely on the dissolution time of the cellulose, and the exact dissolution time depends not only on the treatment in the high-shear unit but rather also for example on the cellulose concentration, the cellulose type, the pretreatment thereof, and the type of the functional medium, and can also extend beyond these ranges. In the case of a kneader-mixer volume of 2500 I, an industrial production capacity of for example 6.4 kilotons per year of cellulose (or, in the case of further processing, cellulose fibres) can be achieved. In this case, heating of the discs of the kneader shaft and division into a plurality of temperature zones can be omitted, if the product is introduced into the kneader-mixer at a concentration corresponding to a 1.3 hydrate. This corresponds to a dwell time of approx. 12 minutes, which cannot be achieved in the prior art for a drying method using an extruder.

Specifically, in the case of use of NMMO and IL as a functional medium, the transfer mixture is characterised in that the state of the product has not yet achieved that of a moulding solution. This can be characterised in that the thermomechanical treatment of the starting material in the preceding process stage is insufficient, in the sense that the dissolution time provided in the high-shear unit for the present mixing and kneading action is too short, or that the water content is still too high due to insufficient or lacking evaporation.

The need to start the dissolution process in the kneader-mixer in the scope of the invention with a transfer mixture is due to the inadequate ability of kneader-mixers, due to low shearing, to sufficiently mix liquids into a powdered solid and to prevent or to comminute cellulose agglomerates to such an extent that they can be dissolved in the kneader-mixer by the functional medium. Thus, the production of a transfer mixture from a starting material consists mainly of mechanical processing, in particular mixing and shearing, such that the transfer mixture differs compared with the starting material in particular by its increased homogeneity, while the composition remains substantially unchanged and the dissolution process does not yet start, or only in part. In this connection, “substantially unchanged” relates in particular to the water content of the product, which a reduce by evaporation or vaporisation as a result of input of in particular dissipation energy into the high-shear unit during the processing of the starting material for the transfer mixture.

The transfer mixture differs from the moulding solution in that it corresponds to the product in a state before it is transferred into a moulding or spinnable solution, i.e. the moulding solution. A moulding or spinnable solution exists when all the essential cellulose components of the starting material have dissolved. In this connection, “essential” means a fraction of non-dissolved components that is so small that the so-called filter lifetimes reach an economically acceptable level.

A filter service life relates to filters which are typically used after the process stage for producing the moulding solution and before the process stage for shaping or spinning. The filter service life corresponds to the time duration or the usage duration until a filter has to be changed, because the pressure drop over the filter is too great, which increases due to the accumulation of components that are not desired for further processing. Said components can for example constitute both non-dissolved cellulose fibres and also non-cellulose impurities. The specific selection of a filter service life is therefore subject to macroeconomic costs and quality-optimising aspects.

The transfer mixture furthermore differs from the starting material in that, due to thermomechanical or exclusively mixing treatment in the preceding process member, the transfer mixture has greater homogeneity and is still preset as a suspension or a partial solution. In the embodiment having a water content in the starting material that is higher than is necessary for a moulding solution, the kneader-mixer according to the invention for processing the transfer mixture is, as mentioned, characterised in that the product in the kneader-mixer has a water content that corresponds to the water content which still has to and can be evaporated during the dissolution time, without increasing the process volume of the kneader-mixer, which has the advantage that the kneader-mixer can be constructed to be as small as possible, and ideally not all the surfaces have to be heated.

This leads to an optimal use of the kneader-mixer, since its strength is kneading with little mechanical power input, based on the process volume, compared with high-speed high-shear units, and a freely selectable dwell time in the continuous mode of operation for the complete dissolution of the cellulose. This is in particular also advantageous since at the same time use is made of the strength of the high-shear unit, specifically mixing and kneading with high volume-based mechanical power input at comparatively low dwell times of typically 0.2 seconds to 2 minutes is used for processing the starting material to form a transfer mixture.

In the case of use of the large-volume high-shear units as a process stage upstream of the kneader-mixer according to the invention, the optimal use of the kneader-mixer lies in the continuous operating mode with a substantially freely selectable dwell time and not only mechanical but typically also thermal energy input for the complete dissolution of the cellulose. The advantage of the mentioned continuous operating mode lies in the prevention of time-consuming cleaning cycles and the minimisation of quality fluctuations that are highly relevant for the moulding solution and shaping quality. This is in particular also advantageous since at the same time use is made of the strength of the large-volume high-shear unit, specifically the simple metering ability and the mixing—in and kneading of large amounts of powder into a liquid for processing the starting material to form a transfer mixture.

The mechanical power input, based on the process volume, relates to a typical filling level. While this is typically up to 100% in the case of extruders and high-speed mixers, for drying methods for kneader-mixers and Z-kneaders or sigma blade mixers it is typically up to approx. 50% to 70%.

Since evaporation is not a strength of high-shear units, conversely a preceding process member used to its strengths means that the input concentration of water in the transfer mixture substantially corresponds to that in the starting material. In this case, “substantially” relates to the correct operation with optimal setting of the high-shear unit, with the exception of leaks, humidification, or sample removal.

The process volume of the kneader-mixer results, for a specific filling level, from the required moulding solution flow capacity, which results from the dissolution time still required after the thermomechanical pretreatment in the preceding high-shear unit and the dwell time in a possible tank. This in turn is dependent on various factors, such as the cellulose concentration, the particle size of the cellulose, the state of aggregation of the functional medium, the cellulose type, the pretreatment thereof, the functional medium, and the kneading and mixing intensity of the kneader-mixer. The functional medium can exist as a liquid but also for example as a granulate or in powder form, in a solid state of aggregation. A person skilled in the art therefore knows, for example, that cellulose of different origins requires different dissolution times, for example different wood types, other plants such as cotton, or different degrees of polymerisation (known as DP) of the cellulose. A person skilled in the art also knows that mutually deviating dissolution speeds, and thus dissolution durations, can occur in different functional media.

The functional medium is understood independently of its state of aggregation in the starting material. Thus, for example NMMO, when it is mixed as a monohydrate at room temperature in solid form with a cellulose powder, and becomes liquid only in the course of the further processing, is also referred to as a functional medium.

According to the invention, as an additional optimised process variant the speed of the high-shear unit is set such that no mechanical power is introduced into the product which has to be dissipated again by contact cooling in the kneader-mixer according to the invention, for a safe and energy-efficient method. This simplifies the process control and increases the process safety of the method, in particular when NMMO is used as the functional medium. In addition, the described process variant has the advantage of a minimal thermal loading of the mixture in the kneader-mixer, which is beneficial for the product quality of the moulding solution. In terms of apparatus, this means that the kneader shaft does not have to comprise a plurality of heating/cooling zones. In the case of the present invention, the shaft structures are preferably configured to be free of a heating cavity, and the mechanical energy input introduced by kneading is sufficient for producing a moulding solution from the transfer mixture. Ideally, the preceding process member, in the form of a high-shear unit, already processes the product, during production of the transfer mixture, to such an extent that the kneader-mixer according to the invention does not have to remove any water from the transfer mixture, and the dissipation energy leads only to heating of the product, without overheating it, or at least without not substantially overheating it, such that no condensation of water evaporated in the kneader-mixer is required either, and it is fed with a starting material, the water content of which already corresponds to that of a moulding solution.

In the case of NMMO as a functional medium, a preferred embodiment that increases the process safety is characterised in that the water content in the transfer mixture is so high that the water content in the high-shear unit is sufficiently high that the risk of autocatalytic decomposition of the NMMO is low. This is the case as long as the water content of the transfer mixture is in the following general range:

$$minimum {x}_{H 2 O} = - 0.4525 {x}_{Cell} + 0.1465 \\ maximum {x}_{H 2 O} = 0.2864 {x}_{Cell}^{2} - 0.6786 {x}_{Cell} + 0.2288 .$$

The water content of the transfer mixture is preferably in the following preferred range:

$$maximum {x}_{H 2 O} = 0.2864 {x}_{Cell}^{2} - 0.6786 {x}_{Cell} + 0.2288 \\ minimum {x}_{H 2 O} = - 0.00022 {x}_{Cell}^{2} - 0.5317 {x}_{Cell} + 0.18 .$$

In these two equations for a general and a preferred range of an NMMO transfer mixture, X_{H2O} describes the mass fraction of water based on the overall mixture, and x_{cell} describes the corresponding fraction of the cellulose. The energy input of the preceding process member is thus selected such that the required process energy for heating and optionally evaporating the mixture in the kneader-mixer preferably results only from the mechanical power of the kneader-mixer. In this case, the specified water contents relate a range of cellulose contents and cellulose qualities (e.g. molar mass distribution) that is typically in the industry, which cellulose contents and qualities are known to a person skilled in the art. For example, in the case of a cellulose content of 0.110, a minimum water content of 0.097 results for the general transfer range.

Thus, the maximum moulding solution flow capacity per kneader-mixer, as the last process member in a multistage dry dissolution method, and thus the maximum production capacity per production line overall increases.

According to the invention, a mixture preferably and not exclusively containing an IL or NMMO or a protolyte, i.e. an acid or a base, as described for example in CA 3 020 820 A1 or WO 96/06207 A1 and WO 96/06208 A1, is added as a functional medium for the starting material. The functional medium serves for dissolving the cellulose under corresponding requirements.

In the mentioned combination comprising a preceding process member for producing a transfer mixture, a preferred embodiment of the kneader-mixer is characterised in that it is designed for processing a transfer mixture which is selected such that the viscosity of the transfer mixture is not only low enough that significant overheating i the high-shear unit is prevented, but rather also high enough that the mechanical energy input in the case of the kneader-mixer, occurring due to friction, is so high that the need for thermal energy input into the kneader-mixer, supplementing the mechanical energy input, is so low that the structures of the kneader shaft do not have to serve for thermal heat exchange, but rather can be configured to be free of a heating cavity. In this case, a further preferred embodiment is characterised in that the mechanical energy input is selected, by the selection of the size and geometry of the kneader-mixer, the rotational speed of the kneader shaft, the viscosity of the product to be processed, and the dwell time of the product in the kneader-mixer, such that the kneader-mixer can be configured without thermal exchange surfaces of the kneader shaft or the housing, in that the kneader shaft or inner tube or the housing of the kneader-mixer is equipped without a double shell. This allows for a significantly easier, more cost-effective, and faster method of construction of the kneader shaft and of the housing.

In a preceding process step, the starting material is present as a mixture of cellulose, water and functional medium, the composition of which can vary significantly.

In this case, the starting material is made into a transfer mixture, in the preceding process step. This process step can preferably take place in one or more high-shear units as the preceding process member or preceding process members.

In the transfer mixture according to the invention, the cellulose is present as a suspension or partially dissolved. In the case of water evaporation in the kneader-mixer and NMMO as the functional medium, in a mode of operation configured for process safety i the high-shear unit the minimum water content in the NMMO of the transfer mixture can be taken from the mathematical formula.

All these cases share the basis of the inventive concept of using the kneader-mixer according to the invention for a dry or semi-dry moulding solution production. In this connection, semi-dry means that, although water has to be evaporated between the starting material and the moulding solution, this process task is not configuration-determining for the high-shear unit according to the invention and the kneader-mixer according to the invention. It follows from this that the kneader-mixer determines, by the moulding solution flow capacity, what is meant by the smallest possible structural size of the kneader-mixer for a particular moulding solution flow capacity, or the maximum moulding solution flow capacity for a particular kneader-mixer size.

Furthermore, all the cases have in common the concept of compensating the shortcomings of high-shear units using the strengths of the kneader-mixer according to the invention, which shortcomings consist at least in that although the high-shear unit is suitable, at a given capacity, for mixing the components of the starting material to form a transfer mixture, it is, however, not suitable for further processing this transfer mixture to a moulding solution, and that the kneader-mixer is suitable for further processing the transfer mixture to a moulding solution, and is not suitable for mixing the components of the starting material to give a transfer mixture.

Due to its technical properties, such as a small mechanical energy and dissipation energy input compared with a high-shear unit, the kneader-mixer is particularly suitable for processing the product by mixing and kneading from a transfer mixture to a moulding solution, without the product overheating, or without it substantially overheating. In contrast, the high-shear unit has a higher mechanical energy and dissipation energy input, and is therefore suitable for processing the starting material to form the transfer mixture.

Compared with extruders, the kneader-mixers according to the invention are characterised by a dwell time that can be freely selected largely independently of the speed of the kneader shaft and thus independently of the mixing/kneading intensity. This is supported by the comparatively small input, in the kneader-mixer, of dissipation energy per process volume, and, accordingly, reduced heating of the product, which is important owing to the risk of overheating. The kneader-mixer thus makes use of the intensive product contact in extruders, when mixing two powders or one powder into a liquid, and compensates the limited dwell time of extruders.

The kneader-mixer according to the invention is characterised, compared with Z-kneaders or sigma blade mixers, in particular by its continuous mode of operation, which is advantageous for a necessarily low-fluctuation homogeneous moulding solution stream, and makes use of the possibility of Z-kneaders being able to meter powder into a liquid in a simple manner and in large quantities, and mix and knead it by means of intensive product contact.

The kneader-mixer according to the invention is characterised, compared with high-speed mixers whose dwell time is less than 1 minute, preferably less than 30 seconds, and preferably in particular less than 10 seconds, in particular by its freely selectable dwell time and the high torque possibilities of the kneader shaft, and makes use of the capability of high-speed mixers of being able to meter powder into a liquid in a simple manner and in large quantities, and of being able to mix with high specific power input. Compared with all other high-shear units and kneader-mixers, high-speed mixers are typically characterised by applications having low product viscosities, and therefore they are not prior art for moulding solution methods. Their use as a preceding process member of the kneader-mixer according to the invention in the dry dissolution method is based on the inventive concept that the mixing—in takes place so quickly that likewise no substantial viscosity increase of the product yet occurs because the dwell time is too short for this, and therefore the dissolution process cannot start or cannot develop to such an extent that it allows for such a significant increase in the viscosity of the product that this exceeds the torque limit of the high-speed mixer.

The formulas for describing the transfer mixture with NMMO as a functional medium relate to the production of a transfer mixture under thermomechanical conditions which allow for low-risk operation of the high-shear unit and have proven themselves in practice. However, on account of the explained influences on the dissolution speed of the cellulose, it is possible for the formula to predict a spinnable solution, while in practice, despite low water contents, a transfer mixture according to the invention comprising non-dissolved cellulose components is present, since a special thermomechanical treatment was selected, for example very short times of the product between infeed and outlet. However, on account of the low water content in the transfer mixture, associated therewith, such thermomechanical treatments are at the same time associated with an increased process risk due to substantial overheating at explosive decomposition.

This can furthermore also mean, according to the invention, that also in the case of compositions within the concentration range the starting material is supplied to the preceding process step, which describes the general transfer mixture. Typically, a transfer mixture that is characterised by a partial dissolution of the pulp results only from the process-specific thermomechanical treatment of the starting material (increased temperature and shear action).

Compared with processes for producing a transfer mixture that have a significant water content to evaporate in the preceding process member and that typically use a thermal energy input via hot surfaces for the evaporation, the high-shear unit and kneader-mixer can, in particular by virtue of good mixing properties and effective mechanical energy input via the rotating shaft, quickly set the speed and thus also the energy input, and also cancel these again quickly. For this reason, and due to their high mixing intensity and consequently their small radial temperature gradient, high-shear units and kneader-mixers are suitable for regulating the temperature, and thus generally cooling or heat dissipation, with a high degree of accuracy- and, in the case of NMMO as the functional medium, also safely- and thus also preventing overheating or substantial overheating.

In another embodiment, the transfer mixture first passes a transfer member or transfer members following the high-shear unit or the plurality of high-shear units, before it is introduced into the kneader-mixer.

Thus, the increased energy efficiency and process safety applies not only for the process step of producing the moulding solution from the transfer mixture in the kneader-mixer, but rather also in combination with a suitable preceding process member for the entire transfer of a starting material into a moulding solution.

The material properties based on the formulas set out above for describing the general transfer range with NMMO as a functional medium result from the following studies.

For the general transfer region set out above, the minimum water content X_{H2O}, describes for a person skilled in the art, based on U.S. Pat. No. 4,196,282 A, the composition in which, following visual examination, crystals of the NMMO could be observed for the first time in the cellulose/water/NMMO mixture. It thus delimits the mixtures capable of forming complete moulding solutions upon corresponding thermomechanical treatment, from the crystal phase. The statements made in U.S. Pat. No. 4,196,282 A with respect to NMMO as the functional medium are confirmed by the results and observations from industrial applications and tests by the inventors at the pilot-plant scale. The formula for describing the maximum water content x_{H2O} of the general transfer range is based on findings from industrial applications of the direct dissolution method and data collection from test series by the inventor at the pilot-plant scale. It marks the upper limit of the transfer range, within which an optimum use of the specific process-relevant kneader-mixer features is ensured. The two formulas set out here therefore enclose the range of the general transfer mixture.

Regarding the description of the material properties of the preferred transfer range, with regard to the minimum water content reference should be made inter alia to U.S. Pat. No. 4,196,282 A. The formula combines findings of the limit curves, described in U.S. Pat. No. 4,196,282 A, of the dissolution region with results from industrial applications of the direct dissolution method and data collection from test series by the inventor at the pilot-plant scale. The description of the maximum water content corresponds, in the preferred range, to that of the general transfer range.

The transfer mixture is in a pre-dissolution state in its general composition and also in its preferred composition, also on account of the thermomechanical treatment and treatment duration selected in the high-shear unit. This has also resulted in the moulding solution method taking place under optimal operating parameters of the high-shear unit, and the comparatively difficult material states of the moulding solution being prevented, if for example overdrying or decomposition takes place in the high-shear unit, due to too significant a shear action. These difficult material states do not lead, in the following kneader-mixer according to the invention, to problematic process states, because said kneader-mixer is characterised by a reduced shear action and a dwell time that is independent of the mixing and kneading action.

In the case of the formula which describes the general composition, and provided that NMMO is used as the functional medium, an application of the transfer mixture is advantageous which mixture still contains such an amount of water that further processing for dissolution can take place in the following process member in a relatively short process time, and furthermore crystallisation of the solvent is prevented.

In the case of the formula which describes the preferred composition of the transfer mixture, the minimum content of water is further from the crystal phase, compared with the definition of the general transfer mixture. Thus, the processing of the transfer mixture to form a moulding solution in the kneader-mixer according to the invention can be achieved in a short process time, and at the same time the risk of overdying of the material can be reduced.

In both cases of the formula the transfer mixture, but with a processing time lasting from two to several minutes, during which the product is homogenised in the kneader-mixer and optionally remaining water is evaporated, is removed from a shapable or spinnable solution.

The product, and thus also the starting material, substantially contain cellulose, water and a functional medium. In addition, the product contains further chemicals such as stabilisers etc., a detailed list of which can be omitted in the context of the invention, since they are known to a person skilled in the art and require adjustments for every individual application.

A person skilled in the art furthermore knows methods for producing a moulding solution of pulp according to a dissolution method, in which the functional media consist substantially of a protolyte, such as in particular a phosphoric acid or a sodium hydroxide solution, and in which typically no evaporation of water takes place, but rather dissolution must take place, in particular at least in part around or below the freezing point, and a moulding solution results by a combination of mixing a shearing for a certain dwell time. These dissolution methods (also referred to as cold methods) are also characterised in the prior art, in the case of use of a high-shear unit, by a limited capacity of the moulding solution stream, specifically in the case of use of an extruder on account of the limited dwell time, typical for extruders, or by limited cooling capacity, specifically in the case of use of a continuous mixer, owing to their limited cooling surfaces due to non-heatable or non-coolable shafts and shaft discs.

In one embodiment, the high-shear unit consists of at least two large-volume high-shear units, for example in the form of Z-kneaders, i.e. of a first Z-kneader and a further Z-kneader, which are connected upstream of the kneader-mixer, one behind the other or side-by-side. The Z-kneaders have the advantage that the starting material is processed to form the transfer mixture independently of the kneader-mixer, and only supplied to the kneader-mixer when this is desired or a corresponding time window is present. In the case of use of a plurality of Z-kneaders arranged side-by-side, for example in the case of unloading of the transfer mixture from the first Z-kneader into the kneader-mixer, the further Z-kneader can produce a transfer mixture from the starting material independently thereof, and as soon as the first Z-kneader is unloaded, the further Z-kneader can be supplied to the kneader-mixer for unloading. This procedure can take place in an alternating manner.

A further embodiment consists in producing the transfer mixture in batches in a first Z-kneader, which mixture is fed in batches via a discharge screw to a second Z-kneader, the capacity of which is selected such that it can collect the filling level fluctuations of the second Z-kneader, occurring as a result of the batchwise discharge out of the first Z-kneader, and can continuously supply the following kneader-mixer via the discharge screw. Instead of the second Z-kneader, a stirring tank equipped with a discharge screw is also conceivable.

The kneader-mixer according to the invention, and the method according to the invention, associated therewith, relate, in this invention, to dry dissolution methods which differ according to a direct dissolution method without evaporation of water, a direct dissolution method with evaporation of water, and a protolyte dissolution method.

It can also be provided for the transfer mixture to be produced in a preceding process member, from the starting material, as a premixture (also referred to as a premix), and said premix is then introduced into the high-shear unit as a stirred starting material.

The parameters of the high-shear unit are also selected such that the composition of the transfer mixture and the composition of the starting material are substantially identical.

It can furthermore be provided that the kneader shaft of the kneader-mixer wipes the product in a rotating manner over heated and/or cooled inner surfaces of the kneader-mixer. It can also furthermore be provided for the shaft structures of the kneader shaft of the kneader-mixer to be configured at least in part, for example in axial portions of the kneader shaft, to be free of a heating cavity.

Furthermore, the composition of the transfer mixture can be identical to the composition of the starting material, and the water content in the starting material can be selected such that so much water of the transfer mixture evaporates in the kneader-mixer, by the mixing/kneading interaction and by means of heated surfaces, that the evaporation cooling occurring in the process results in a moulding solution without substantially overheating the product in the process.

Evaporation cooling for the purpose of preventing overheating or substantial overheating of the product can furthermore also be achieved or increased in that water (also referred to, in the context of this invention, as evaporation cooling water) is directly added into the kneader-mixer. Said water is heated, at the surface of the product, to its boiling temperature, such that it evaporates immediately, without being substantially mixed into the product, and accordingly without substantially increasing the water content of the product. As a result, heat is withdrawn from the product and said product is thus cooled.

The energy supply and the energy dissipation of the thermally heatable or coolable inner surfaces, also referred to as thermal exchange surfaces, of the process chamber, generally takes place via a heating medium. Typical heating media are heat carriers such as water, steam or other, usually synthetic, liquids, which flow through the thermal exchange surfaces of the kneader-mixer, and possibly an associated dome, or coils which are built into thermal exchange surfaces and through electrical current flows, and which thus heat up, in order to heat or cool the process chamber-side surfaces of the kneader-mixer in an energy-supplying manner.

Evaporation cooling water is characterised in that it is added directly to the kneader-mixer and via a separate supply line, and is not already contained in the starting material and does not enter the kneader-mixer as part of the transfer mixture. The supply typically takes place via a controllable valve, such that the amount of water per time unit is purposely matched to the evaporation cooling to be achieved. In this case, the temperature of the evaporation cooling water immediately before the entry into the process chamber of the kneader-mixer, and the gas pressure in the process chamber of the kneader-mixer, are selected such that the temperature of the evaporation cooling water is below the boiling point of water in the process chamber of the kneader-mixer, such that as little water as possible evaporates by a flash, known to a person skilled in the art, and as much water as possible reaches the surface of the product.

Evaporation cooling can also take place by way of the evaporation of a liquid (also evaporation cooling medium) other than water. The evaporation cooling medium can be added to the high-shear unit together with the starting material, or can be added directly to the process chamber of the kneader-mixer, instead of the evaporation cooling water. Evaporation cooling can also take place by partial evaporation of the functional medium, wherein the evaporating portion of the functional medium is also referred to as the evaporation cooling medium.

Cooling of the product for the purpose of preventing overheating or substantial overheating of the product can furthermore also be achieved or increased by wiping the product over the at least partially cooled inner surfaces of the kneader-mixer.

### BRIEF DESCRIPTION OF THE DRAWINGS

Further advantages, features and details of the invention emerge from the following description of preferred embodiments and on the basis of the drawings, in which:

FIG. 1 schematically shows a system comprising a kneader-mixer 6 without evaporation;

FIG. 2 schematically shows a system comprising the kneader-mixer 6 with evaporation;

FIG. 3 schematically shows a system comprising a high-speed high-shear unit 5 and the kneader-mixer 6;

FIG. 4 schematically shows a system comprising two large-volume high-shear units 8 and the kneader-mixer 6:

FIG. 5 schematically shows a further embodiment of a system according to the invention:

FIG. 6 is a first graph showing the preferred material properties of a transfer mixture;

FIG. 7 is a second graph showing the general material properties of the transfer mixture.

### DETAILED DESCRIPTION

Initially, it is noted that embodiments and features of individual components in the explanation for one figure are also intended to apply for the other figures. This is the case in particular if the same reference signs are used for the same components in different figures.

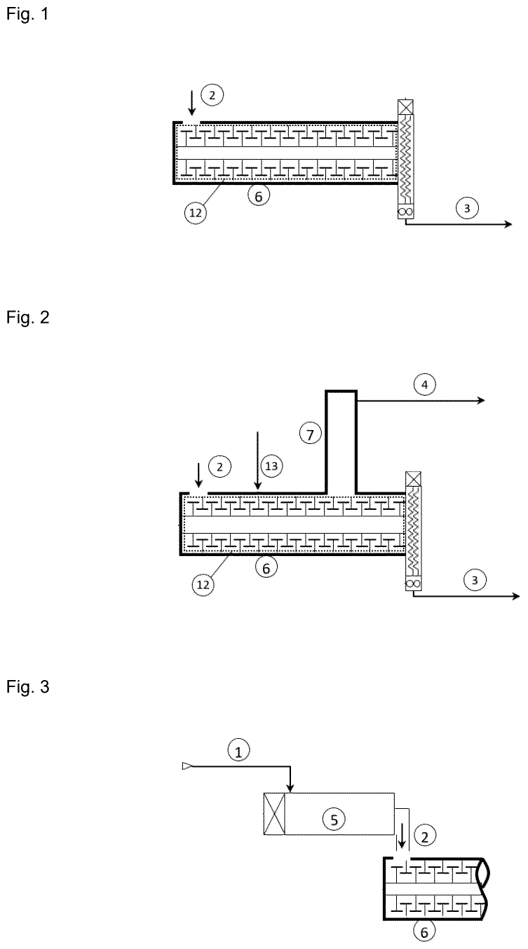

FIG. 1 shows a kneader-mixer 6. The process chamber 12 is located in the interior of the kneader-mixer 6. The process chamber 12 is fed at one end by a continuous stream of transfer mixture 2, and at the other end a moulding solution or a moulding solution stream 3 leaves the kneader-mixer 6. In the embodiment shown here, the kneader-mixer 6 is operated without evaporation.

FIG. 2 shows a system in which the kneader-mixer 6 is operated with evaporation. For this purpose, the kneader-mixer 6 again has a continuous stream of transfer mixture 2 at one end, and again the moulding solution or the moulding solution stream 3 at the other end. In addition, the supply of evaporation cooling water 13 is shown schematically by an arrow. In addition, the process chamber 12 or the kneader-mixer 6 comprises a dome 7. In turn, facing away from the dome 7, a second arrow is shown schematically for a vapour stream 4.

The kneader-mixer 6 is shown in part in FIG. 3. The way in which the continuous stream of transfer mixture 2 is delivered from a high-speed high-shear unit 5 to the kneader-mixer 6 is furthermore visible. The way in which a continuous supply of the components of a starting material 1 is introduced into the high-speed high-shear unit 5 is shown schematically by a third arrow.

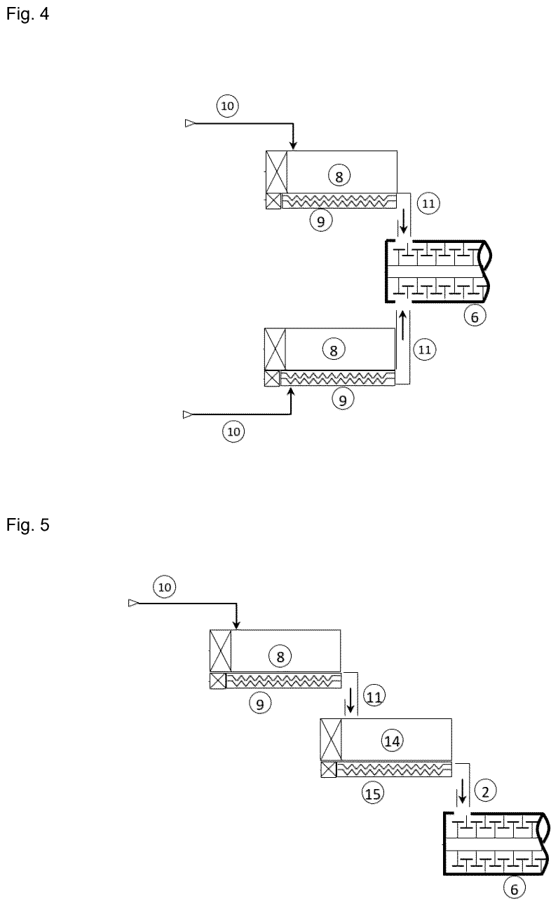

FIG. 4 shows how two large-volume high-shear units 8, arranged side-by-side, are operated alternately in a batchwise manner, and in the process in each case output a batchwise stream of transfer mixture 11 into the kneader-mixer 6. For this purpose, the large-volume high-shear units 8 in turn each comprise a discharge member 9 that is operated in a batchwise manner. In addition, a batchwise supply of the components of the starting material 10 into the large-volume high-shear unit 8 is shown schematically in each case by a fourth arrow.

FIG. 5 schematically shows a further embodiment of a system according to the invention. Here, an additional operating part is shown between the kneader-mixer 6 and the large volume high-shear unit 8. Said additional operating part is either a further large-volume high-shear unit or a stirred container 14. In this case, it is thus possible to provide either the further large-volume high-shear unit or the stirred container 14. What is important in the selection is the requirement for the additional operating part to comprise a continuously operated discharge member 15, and thus to allow for the continuous stream of transfer mixture 2 into the kneader-mixer 6. In this case, the large-volume high-shear unit 8 has a discontinuous feed of the further large-volume high-shear unit or of the stirred container 14, in the form of the batchwise stream of transfer mixture 11. In contrast, the further large-volume high-shear unit or the stirred container 14 supplies the kneader-mixer 6 with a continuous stream of transfer mixture 2. With regard to the large-volume high-shear unit 8, the statements relating to one of the large-volume high-shear units 8 from FIG. 4 apply.

Combinations of the systems from FIGS. 1 to 5 are to be considered to also be disclosed in the context of the invention, if the combination is not in any case mutually exclusive.

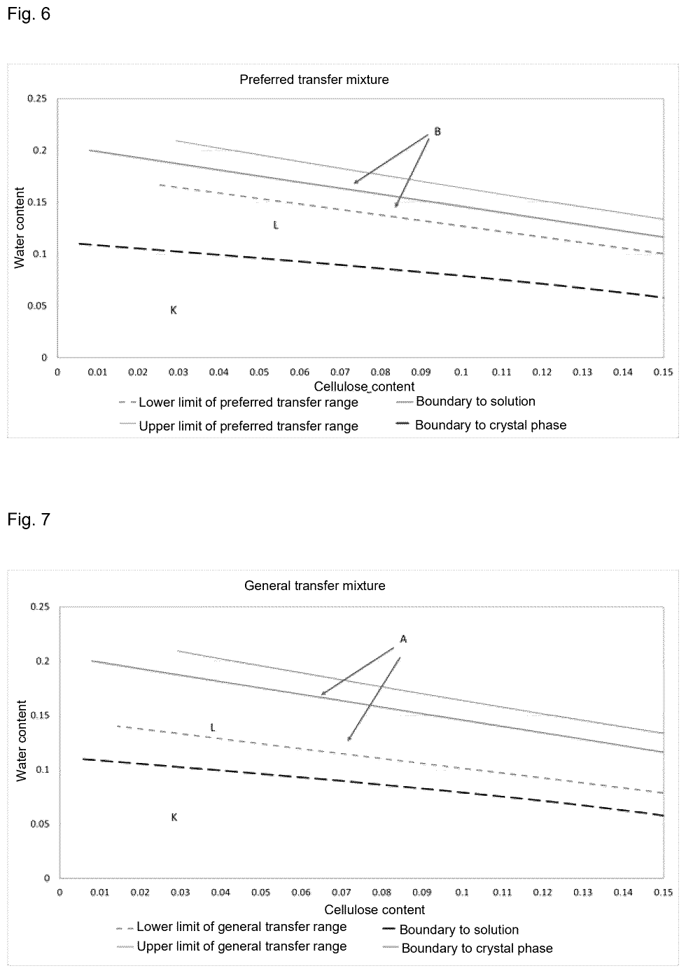

FIGS. 6 and 7 schematically show the equations for the general and preferred range of an NMMO transfer mixture.

In this case, the general composition a has the following parameters of

$$maximum {x}_{H 2 O} = 0.2864 {x}_{Cell}^{2} - 0.6786 {x}_{Cell} + 0.2288 \\ minimum {x}_{H 2 O} = - 0.4525 {x}_{Cell} + 0.1465$$

and thus has a greater range than the preferred composition b, which has the following parameters of

$$maximum {x}_{H 2 O} = 0.2864 {x}_{Cell}^{2} - 0.6786 {x}_{Cell} + 0.2288 \\ minimum {x}_{H 2 O} = - 0.00022 {x}_{Cell}^{2} - 0.5317 {x}_{Cell} + 0.18 .$$

In the case of a decreasing water content, first the range of the solution L is reached, and upon a further decrease of the water content the crystallisation K of the NMMO occurs.

The use of equations for the general and preferred range of an NMMO transfer mixture shows, in the following, the example for the production of a moulding solution having a cellulose content of 12 wt. % with the aid of the direct dissolution method with NMMO as a functional example and without significant evaporation of water during the process.

All the following content specifications relate to the total mass of the cellulose/NMMO/water mixture. A starting material having a cellulose content of approx. 12.0 wt. % is produced from cellulose and NMMO monohydrate, such that an NMMO content of approx. 77.4 wt. % results.

This starting material is introduced into a high-shear unit with a stream of approx. 217 kg/h, and is processed there to form a transfer mixture. In the example, the high-shear unit is operated at atmospheric pressure.

In the present example, the heating temperature of the high-shear unit is 90° C., and therefore overheating of the product is avoided. The transfer of the mixture takes place after thermomechanical treatment in the high-shear unit, at a product temperature of approx. 105° C.

The ratio of water and NMMO has remained constant, compared with the start of the process. The transfer mixture provided by the high-shear unit subsequently passes into the kneader-mixer with a stream of approx. 217 kg/h.

There, the complete dissolution of the cellulose and homogenisation of the mixture by the kneading and mixing effect takes place, such that a complete moulding solution results. The dwell time of the mixture in the kneader-mixer is 8.5 minutes.

The process volume of the kneader is therefore approx. 70 1. The moulding solution leaves the kneader-mixer with a stream of approx. 217 kg/h having a cellulose content of 12.0 wt. %, an NMMO content of approx. 77.4 wt. %, and a temperature of approx. 107° C.

List of reference signs

| | |
|---|---|
| 1 | Continuous addition of the components of the starting material |
| 2 | Continuous stream of transfer mixture |
| 3 | Moulding solution or moulding solution stream |
| 4 | Exhaust stream |
| 5 | High-speed high-shear unit |
| 6 | Kneader-mixer |
| 7 | Dome |
| 8 | Large-volume high-shear unit |
| 9 | Discharge member operated in a batchwise manner |
| 10 | Batchwise addition of the components of the starting material |
| 11 | Batchwise stream of transfer mixture |
| 12 | Process chamber |
| 13 | Evaporation cooling water |
| 14 | Large-volume high-shear unit or stirred tank |
| 15 | Continuously operated discharge member |
| A | General composition of the transfer mixture |
| B | Preferred composition of the transfer mixture |
| K | Crystallisation |
| L | Solution |

The invention claimed is:

1. Method for processing a moulding solution from a starting material that consists of cellulose, water and a functional medium, according to the dry dissolution method, wherein the starting material is first supplied to a high-shear unit (5, 8),
wherein
a transfer mixture (A, B) is obtained from the starting material in the high-shear unit (5, 8), and the transfer mixture (A, B) is then supplied to a kneader-mixer (6) for dissolution.

2. Method according to claim 1, wherein the composition of the starting material and the composition of the transfer mixture (A, B) are substantially identical.

3. Method according to claim 1, wherein a machine controller monitors and controls or regulates the content of water, cellulose and functional medium in the composition of the product from the starting material up to the moulding solution, the product temperature, the viscosity of the product, the pressure or the temperature of the heating medium, the pressure in the process chamber (12), the rotational speed or the torque of a kneader shaft via sensors.

4. Method according to claim 1, wherein at least a portion of an inner surface of the kneader-mixer (6) is heated and/or cooled.

5. Method according to claim 1, wherein the water content in the transfer mixture (A, B) is greater than in the moulding solution and water is evaporated in the kneader-mixer (6).

6. Method according to claim 5, wherein the energy required for the evaporation of the water results substantially to exclusively via dissipation due to the interaction of the kneading elements, meshing due to the rotation of the kneader shaft, with the product.

7. Method according to claim 5, wherein the energy required for the evaporation of the water results substantially to exclusively via dissipation due to the interaction of the kneading elements, meshing due to the rotation of the kneader shaft, with the product, and via heated thermal exchange surfaces.

8. Method according to claim 5, wherein the shaft structures of the kneader shaft are configured to be free of heating cavities, at least in part.

9. Method according to claim 5, wherein the evaporation cooling, resulting from the evaporation of water at the product surface, dissipates energy for cooling the product.

10. Method according to claim 1, wherein evaporation cooling water (13) is supplied to the kneader-mixer (6) and the evaporation cooling resulting from the evaporation of evaporation cooling water (13) at the product surface dissipates energy for cooling the product.

11. Method according to claim 5, wherein for the purpose of evaporation cooling an evaporation cooling medium is evaporated instead of the water or in addition to the water, which evaporation cooling medium is either supplied to the high-shear unit (5, 8) together with the starting material or is fed directly into the process chamber (12) of the kneader-mixer (6), instead of the evaporation cooling water (13).

12. Method according to claim 1, wherein a cooled thermal exchange surface energy for cooling the product.

13. System for producing a moulding solution from a starting material that consists of cellulose, water and a functional medium, according to the dry dissolution method, comprising a kneader-mixer (6) and a high-shear unit (5, 8), wherein the high-shear unit (5, 8) is connected directly or indirectly upstream of the kneader-mixer (6).

14. System according to claim 13, wherein the process volume of the kneader-mixer (6) is configured for a capacity which corresponds exclusively to the moulding solution flow capacity.

15. System according to claim 13, wherein the high-shear unit (5, 8) of comprises a first large-volume high-shear unit (8) and a further large-volume high-shear unit (8) which are connected upstream of the kneader-mixer (6), in a manner arranged one behind the other or side-by-side.

16. System according to claim 13, wherein the high-shear unit is configured as a continuously operated high-speed high-shear unit (5).
